(19) United States
(12) Patent Application Publication
(10) Pub. No.: US 2026/0170770 A1
(43) Pub. Date: Jun. 18, 2026

(54) THREE-DIMENSIONAL REGISTRATION METHOD FOR HETEROGENEOUS THREE-DIMENSIONAL VIRTUAL MODELS AND COMPUTING DEVICE THEREFOR

(71) Applicant: 3I INC., Daegu (KR)

(72) Inventors: Ken KIM, Seoul (KR); Ji Wuck JUNG, Goyang-si (KR)

(73) Assignee: 3I INC., Daegu (KR)

(21) Appl. No.: 19/378,981

(22) Filed: Nov. 4, 2025

Related U.S. Application Data
(63) Continuation of application No. PCT/KR2024/097165, filed on Dec. 19, 2024.

(30) Foreign Application Priority Data
Dec. 18, 2024 (KR) 10-2024-0189942

(51) Int. Cl. G06T 19/00; G06T 7/33; G06T 7/55; G06T 7/73; G06T 17/05; G06T 17/10; G06T 17/20

(52) U.S. Cl. CPC G06T 19/006; G06T 7/344; G06T 7/55; G06T 7/74; G06T 17/05; G06T 17/10; G06T 17/20; G06T 2207/10028; G06T 2207/10032; G06T 2207/30244; G06T 2210/56; G06T 2219/2004

(57) ABSTRACT

According to an embodiment of the present disclosure, a three-dimensional registration method for three-dimensional virtual models is performed in a computing device and includes generating a three-dimensional interior digital model for an indoor space using a plurality of data sets collected in the indoor space, generating a three-dimensional exterior digital model for the outdoor space using a plurality of image sets collected in an outdoor space, generating an outline-based three-dimensional volume model for the three-dimensional interior digital model and the three-dimensional exterior digital model, and performing registration between the three-dimensional interior digital model and the three-dimensional exterior digital model based on external fit between the three-dimensional interior volume model and the three-dimensional exterior volume model.

### CROSS-REFERENCE TO RELATED APPLICATION(S) AND CLAIM OF PRIORITY

This application is based on and claims priority under 35 U.S.C. § 119 to Korean Patent Application No. 10-2024-0189942, filed on Dec. 18, 2024, in the Korean Intellectual Property Office, the disclosure of which is herein incorporated by reference in its entirety.

### 1. Field

This application relates to a three-dimensional registration method for heterogeneous three-dimensional virtual models and a computing device therefor.

### 2. Description of Related Art

In recent years, by receiving an online virtual space corresponding to a real space, a virtual space implementation technology that enables a user to experience as if in a real space without directly visiting the real space is being developed. Such real space-based virtual technology is a technology for implementing a digital twin, and various developments are being made.

Meanwhile, methods of implementing digital models constituting a virtual space have been developed in various ways. For example, in the case of constructing a digital model for a wide area using a plurality of images captured by a drone, a method of generating a three-dimensional model as a common feature point after inversely calculating camera positions and poses for the plurality of images may be used. On the other hand, in the case of using a distance measurement sensor such as LiDAR for an indoor space, a method of making a 3D model by projecting a photographing point on 3D spatial coordinates and then reflecting distance data may be used.

As described above, different digital model construction technologies exist according to the difference between the space to be photographed and the photographing device, and accordingly, there is a limitation in that interoperability between digital models implemented in such different methods is insufficient and separate individual systems must be implemented. As a result, there is a problem that becomes an obstacle to the spread of digital twins.

Therefore, there is an increasing need for a technology for fusion between different heterogeneous digital models.

### SUMMARY

One aspect of the present disclosure is to solve the above-described problems, and an object of the present disclosure is to provide a three-dimensional registration technology for three-dimensional virtual models capable of providing a convergenced digital twin providing a heterogeneous digital model in one convergence environment by expressing heterogeneous three-dimensional models configured in different manners through one interface.

One aspect of the present disclosure is to provide a three-dimensional registration technology for three-dimensional virtual models, which is capable of efficiently and quickly registering heterogeneous digital models with fewer resources by generating an outline-based volume model and performing registration on heterogeneous three-dimensional digital models configured in different ways.

One aspect of the present disclosure is to provide a three-dimensional registration technology for three-dimensional virtual models, which is capable of accurately performing scaling with only a small resource while being efficient by performing scaling based on an outline-based volume model with respect to heterogeneous three-dimensional digital models configured in different manners.

One object of the present application is to provide a three-dimensional registration technology for three-dimensional virtual models, which can represent heterogeneous three-dimensional digital models configured in different ways to be seamlessly converted into each other within one interface, and can provide a user with a high sense of immersion by fitting registration and scaling between heterogeneous digital models and display a more complex digital model through one user interface.

However, the problems to be solved in the present disclosure are not limited to the above-mentioned problems, and may be variously expanded within the scope of the spirit and the scope of the present disclosure.

One technical aspect of the present invention proposes a three-dimensional registration method for three-dimensional virtual models. The three-dimensional registration method for the three-dimensional virtual models is performed in a computing device and includes the steps of: generating a three-dimensional interior digital model for an indoor space by using a plurality of data sets collected in the indoor space; generating a three-dimensional exterior digital model for the outdoor space by using a plurality of image sets collected in the outdoor space; generating an outline-based three-dimensional volume model for the three-dimensional interior digital model and the three-dimensional exterior digital model; and performing registration between the three-dimensional interior digital model and the three-dimensional exterior digital model based on external alignment between the three-dimensional interior volume model and the three-dimensional exterior digital model.

Another technical aspect of the present invention proposes a computing device that performs three-dimensional registration on heterogeneous three-dimensional virtual models. The computing device includes at least one processor and a memory storing instructions. The instructions, when executed individually or collectively by the at least one processor, cause the processor to generate a three-dimensional interior digital model for the indoor space using a plurality of data sets collected in the indoor space, generate a three-dimensional exterior digital model for the outdoor space using a plurality of image sets collected in the outdoor space, generate an outline-based three-dimensional volume model for the three-dimensional interior digital model and the three-dimensional exterior digital model, and perform matching between the three-dimensional interior digital model and the three-dimensional exterior digital model based on external alignment between the three-dimensional interior volume model and the three-dimensional exterior volume model.

Another technical aspect of the present invention proposes a storage medium. The storage medium is a storage medium storing computer-readable instructions, and the instructions, when executed by a computing device, cause the computing device to perform an operation of generating a three-dimensional interior digital model for an indoor space by using a plurality of data sets collected in the indoor space, generating a three-dimensional exterior digital model for the outdoor space by using a plurality of image sets collected in the outdoor space, generating an outline-based three-dimensional volume model for the three-dimensional interior digital model and the three-dimensional exterior digital model, and performing matching between the three-dimensional interior digital model and the three-dimensional exterior digital model based on external alignment between the three-dimensional interior volume model and the three-dimensional exterior volume model.

The means for solving the above problems do not list all the features of the present invention. Various means for solving the problem of the present invention will be understood in more detail with reference to the detailed embodiments of the following description.

According to the present application, there are one or more of the following effects.

According to an embodiment of the present invention, it is possible to provide a convergenced digital twin providing a heterogeneous digital model in one convergence environment by expressing heterogeneous three-dimensional models configured in different ways through one interface.

According to an embodiment of the present invention, by generating an outline-based volume model and performing matching with respect to heterogeneous three-dimensional digital models configured in different ways, it is possible to efficiently and quickly match the heterogeneous digital models with fewer resources.

According to an embodiment of the present invention, scaling is performed based on an outline-based volume model with respect to heterogeneous three-dimensional digital models configured in different ways, so that scaling can be accurately performed with efficient and fewer resources.

According to an embodiment of the present invention, provided is an effect of expressing heterogeneous three-dimensional digital models configured in different ways to be seamlessly converted to each other within one interface. In addition, by matching and scaling between heterogeneous digital models, a high sense of immersion may be provided to a user, and a more complex digital model may be displayed through one user interface.

The effects of the present application are not limited to the effects mentioned above, and other effects not mentioned will be clearly understood by those skilled in the art from the description of the claims.

### BRIEF DESCRIPTION OF THE DRAWINGS

FIG. 1 is a diagram illustrating a three-dimensional virtual model fusion providing system according to an embodiment disclosed in the present application.

FIG. 2 is a diagram for describing each component of a system for providing a three-dimensional virtual model fusion according to an embodiment disclosed in the present application.

FIG. 3 is a flowchart illustrating a method of providing fusion for three-dimensional virtual models according to an embodiment disclosed in the present application.

FIG. 4 is a flowchart illustrating a method of generating a three-dimensional exterior model according to an embodiment disclosed in the present application.

FIG. 5 is a flowchart illustrating a method of generating a three-dimensional interior model according to an embodiment disclosed in the present application.

FIG. 6 is a diagram illustrating an example of a three-dimensional exterior model according to an embodiment of the present invention, and FIG. 7 is a diagram illustrating an example of a three-dimensional interior model according to an embodiment of the present invention.

FIG. 8 is a flowchart illustrating a method of generating an outline-based volume model according to an embodiment disclosed in the present application.

FIG. 9 is a diagram illustrating an example of an outline-based volume model according to an embodiment of the present invention.

FIG. 10 is a flowchart illustrating a method of registration between heterogeneous digital models according to an embodiment disclosed in the present application.

FIGS. 11 to 12 are diagrams illustrating examples of registration between heterogeneous digital models according to an embodiment disclosed in the present application.

FIG. 13 is a flowchart illustrating a scaling method between heterogeneous digital models according to an embodiment disclosed in the present application.

FIGS. 14 to 16 are diagrams illustrating an example of scaling between heterogeneous digital models according to an embodiment disclosed in the present application.

FIG. 17 is a flowchart illustrating a method of providing a seamless switching interface between heterogeneous digital models according to an embodiment disclosed in the present application.

FIG. 18 is a diagram illustrating an example of a seamless switching interface between heterogeneous digital models according to an embodiment disclosed in the present application.

FIG. 19 is a diagram illustrating an exemplary structure and operating environment of a computing device according to an embodiment of the present invention.

### DETAILED DESCRIPTION

Hereinafter, embodiments of the present disclosure will be described in detail with reference

to the drawings so that those skilled in the art to which the present disclosure pertains can easily implement the present disclosure. However, the present disclosure may be implemented in various different forms and is not limited to the embodiments described herein. In connection with the description of the drawings, the same or similar reference numerals may be used for the same or similar components. In addition, in the drawings and related descriptions, descriptions of well-known functions and configurations may be omitted for clarity and brevity.

It should be understood that various embodiments of the present disclosure and the terms used therein are not intended to limit the technical features described in the present disclosure to specific embodiments, and include various changes, equivalents, or substitutes of the corresponding embodiment. In connection with the description of the drawings, similar reference numerals may be used for similar or related components. The singular form of the noun corresponding to the item may include one or a plurality of the items, unless the relevant context clearly indicates otherwise. In this document, each of the phrases such as “A or B”, “at least one of A and B”, “at least one of A or B”, “A, B or C”, “at least one of A, B, and C”, and “at least one of A, B, or C” may include any one of the items listed together in the corresponding phrase of the phrases, or all possible combinations thereof. Terms such as “first” or “second” may be used to simply distinguish the corresponding component from other corresponding components, and the corresponding components are not limited to other aspects (e.g., importance or order).

The term “module” used in various embodiments of the disclosure may include a unit implemented in hardware, software, or firmware, and may be used interchangeably with terms such as logic, logical blocks, components, or circuits. The module may be a component configured integrally or a minimum unit of the component or a part thereof that performs one or more functions. For example, according to an embodiment, the module may be implemented in the form of an application-specific integrated circuit (ASIC).

Various embodiments of the disclosure may be implemented as software (e.g., a program) including one or more instructions stored in a storage medium (e.g., a memory) readable by a machine or a device. For example, the processor of the appliance or device may call and execute at least one of the one or more instructions stored from the storage medium. This makes it possible for the device to be operated to perform at least one function according to the at least one instruction called. The one or more instructions may include code generated by a compiler or code that may be executed by an interpreter. The device-readable storage medium may be provided in the form of a non-transitory storage medium. Here, the term “non-transitory” only means that a storage medium is a tangible device and does not include a signal (e.g., electromagnetic waves), and this term does not distinguish between a case in which data is semi-permanently stored in the storage medium and a case in which data is temporarily stored.

According to an embodiment, the method according to various embodiments disclosed in the disclosure may be included in a computer program product and provided. Computer program products may be traded between sellers and buyers as commodities. The computer program product may be distributed in the form of a device-readable storage medium (e.g., compact disc read only memory (CD-ROM)), or may be distributed (e.g., downloaded or uploaded) online through an application store or directly between two user devices (e.g., smart phones). In the case of online distribution, at least a part of the computer program product may be at least temporarily stored in a device-readable storage medium such as a server of a manufacturer, a server of an application store, or a memory of a relay server, or may be temporarily generated.

According to various embodiments, each component (e.g., a module or a program) of the above-described components may include a single or a plurality of entities, and some of the plurality of entities may be separately disposed in other components. According to various embodiments, one or more components or operations of the above-described corresponding components may be omitted, or one or more other components or operations may be added. Alternatively or additionally, a plurality of components (e.g., a module or a program) may be integrated into one component. In this case, the integrated component may perform one or more functions of each component of the plurality of components in the same or similar manner as those performed by a corresponding component of the plurality of components before the integration. According to various embodiments, operations performed by a module, a program, or other components may be sequentially, in parallel, repeatedly, or heuristically executed, one or more of the operations may be executed in a different order, omitted, or one or more other operations may be added.

A processor in the disclosure may mean hardware capable of performing functions and operations according to each name described in the present specification, may mean computer program code capable of performing specific functions and operations, or may mean an electronic recording medium having computer program code capable of performing specific functions and operations. According to an embodiment, the operation of the processor may be defined and/or interpreted as the operation of the digital signage content providing apparatus, but is not limited thereto. The processor may mean a functional and/or structural combination of hardware for performing the technical idea of the present disclosure and/or software for driving the hardware.

The 3D digital model described below encompasses a model expressed in 3D in a virtual space, and is not limited to a specific construction method. Since the 3D digital model refers to an external 3D virtual model, it is obvious that various uses such as constructing a digital twin based on such a 3D digital model are possible.

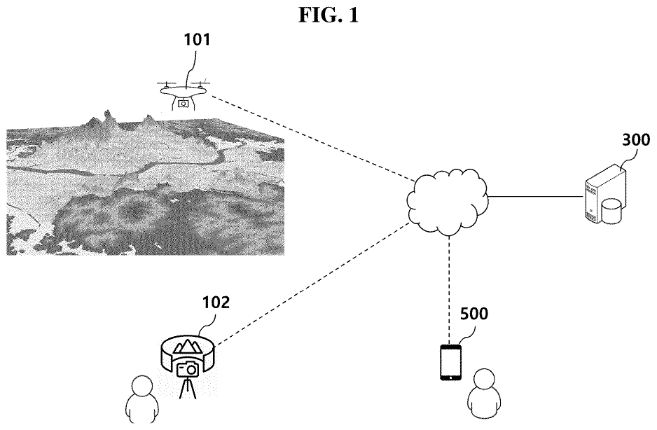

FIG. 1 is a diagram illustrating a three-dimensional virtual model fusion providing system according to an embodiment disclosed in the present application.

The three-dimensional virtual model fusion providing system may include a scan device 100, a computing device 300, and a user terminal 500.

The scan device 100 is an electronic device for generating a photographing data set at each photographing point in the real space.

The scan device 100 may include a first scan device 101 for photographing an outdoor space to generate a digital model for the outdoor space, and a second scan device 102 for photographing an indoor space to generate a digital model for the indoor space.

For example, the first scan device 101 may collect a photographing data set at a plurality of photographing points in the sky of an outdoor space as a flying object such as a drone. For example, the photographing data set may be an image set photographed at a plurality of photographing points, but is not limited thereto.

For example, the second scan device 102 may include a camera and a distance measurement sensor for collecting a photographing data set at a plurality of photographing points of an indoor space. For example, the photographing data set may be a plurality of data sets photographed at a plurality of photographing points. Each data set may include a 360-degree panoramic image, 360-degree depth data (e.g., Depthamp, etc.), and indoor location information (e.g., SLAM-based positioning data, etc.) about a photographing point in an indoor space, which are individually acquired at a corresponding photographing point.

The computing device 300 may configure a three-dimensional virtual model corresponding to a real space based on a plurality of data sets collected from the scan device 100.

The computing device 300 may generate a 3D digital model for an outdoor space by using a plurality of image sets provided from the first scan device 101, and the 3D digital model for the outdoor space generated as described above will be described below as a ‘3D exterior digital model’ or a ‘exterior digital model’.

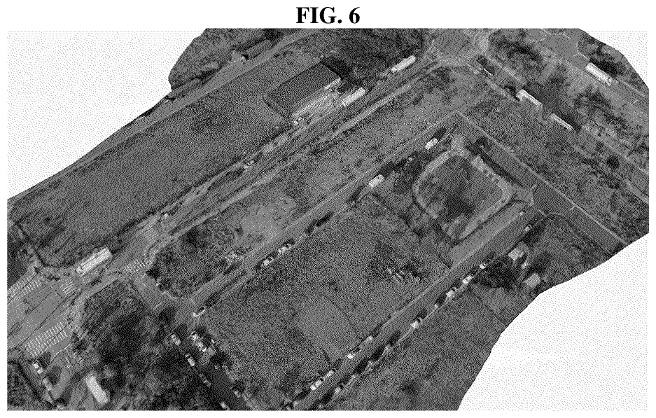

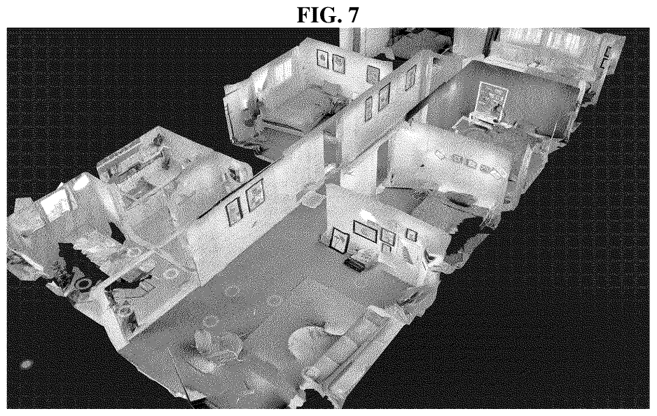

The 3D exterior digital model may have a characteristic of expressing a wide area space, and may be generated based on data having a relatively low density of information (e.g., resolution, etc.). FIG. 6 illustrates an example of such a 3D exterior digital model.

In addition, the computing device 300 may create a 3D digital model for the indoor space by using a plurality of data sets provided from the second scan device 102, and the 3D digital model for the indoor space generated as described above will be described below as a ‘3D interior digital model’ or an ‘interior digital model’.

The 3D interior digital model has a characteristic of representing a relatively collaborative space, especially an indoor space, and may be generated based on data having a relatively high amount of information. FIG. 7 illustrates an example of such a three-dimensional interior digital model.

Meanwhile, the 3D exterior digital model and the 3D interior digital model are configured in different configuration methods based on different photographing data. Therefore, these two models are less consistent with each other. That is, since the two models have different directions, sizes, and the like, in order to express the two models in a fusion manner at the same time, the computing device 300 secures the external unity of the two models through matching and scaling with respect to the heterogeneous three-dimensional digital models configured in such different ways, and provides an interface for providing smooth switching between the two models.

The computing device 300 may provide a fused digital environment of heterogeneous three-dimensional virtual models to the user terminal 500 based on the fusion processing of the two heterogeneous three-dimensional virtual models as described above.

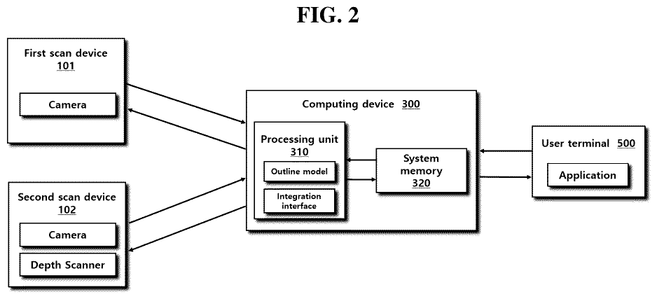

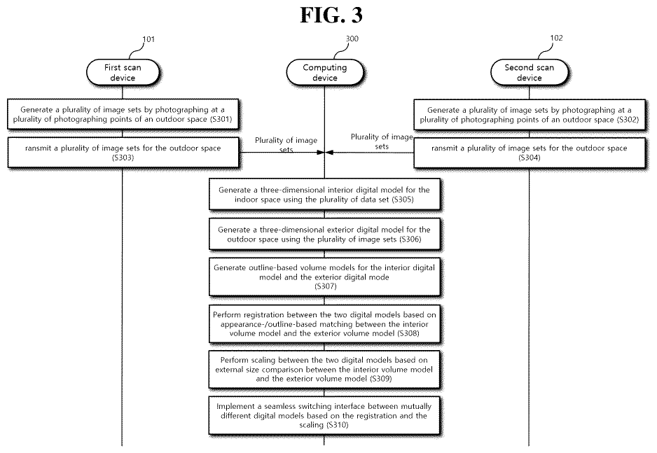

FIG. 2 is a diagram for describing each component of a system for providing a three-dimensional virtual model fusion according to an embodiment disclosed in the present application.

The computing device 300 may include a processing unit 310 and a system memory 320.

The processing unit 310 may include, for example, at least one of a microprocessor, a central processing unit, a processor core, a multi-core processor, a multi-processor, an application-specific integrated circuit (ASIC), or a field programmable gate array (FPGA), but is not limited thereto.

The computing device 300 includes modules constituting different types of digital models, and may include an outline model and an integrated interface for fusing the different types of digital models. Such a model or module may be an artificial intelligence model or a software module that operates individually, and may be implemented as a part of the processing unit 310, but is not limited thereto, and a separate processor may be used for each module.

The system memory 320 may store instructions (or programs) executable by the processing unit 310. The system memory 320 may include a volatile memory or a nonvolatile memory. The volatile memory may be implemented as a dynamic random access memory (DRAM), a static random access memory (SRAM), a thyristor RAM (T-RAM), a zero capacitor RAM (Z-RAM), or a twin transistor RAM (TTRAM). Non-volatile memory may be implemented as Electrically Erasable Programmable Read-Only Memory (EEPROM), flash memory, magnetic RAM (MRAM), spin transfer torque MRAM (Spin-Transfer Torque (STT)-MRAM), Conductive Bridging RAM (CBRAM), ferroelectric RAM (FeRAM), phase change RAM (PRAM), resistive memory (RRAM), Nanotube RRAM, Polymer RAM (PoRAM), nano floating gate memory (NFOAM), holographic memory, Molecular Electronic Memory Device, or Insulator Resistance Change Memory.

The computing device 300 may be implemented as a server, but is not limited thereto.

The first scan device 101 may include a camera for acquiring an image, and the second scan device 102 may include a camera for acquiring an image and a depth scanner for acquiring depth data. The depth scanner may include a predetermined sensor for distance measurement, for example, a LiDAR sensor, an infrared sensor, an ultrasonic sensor, and the like. Alternatively, in order to acquire depth data, the depth scanner may include a stereo camera, a stereoscopic camera, a 3D depth camera, and the like capable of measuring distance information by replacing a sensor.

The user terminal 500 is a device used by a user, and the user may be connected to the computing device 300 through the user terminal 500.

The user terminal 500 is an electronic device in which software such as an application is driven, and may be, for example, a mobile phone, a smart phone, a laptop computer, a digital broadcasting terminal, a personal digital assistants (PDA), a portable multimedia player (PMP), a navigation system, a personal computer (PC), a tablet PC, an ultrabook, a wearable device, for example, a watch-type terminal, a glass-type terminal, a head mounted display (HMD), a virtual display (V) device, or an augmented reality (AR) device.

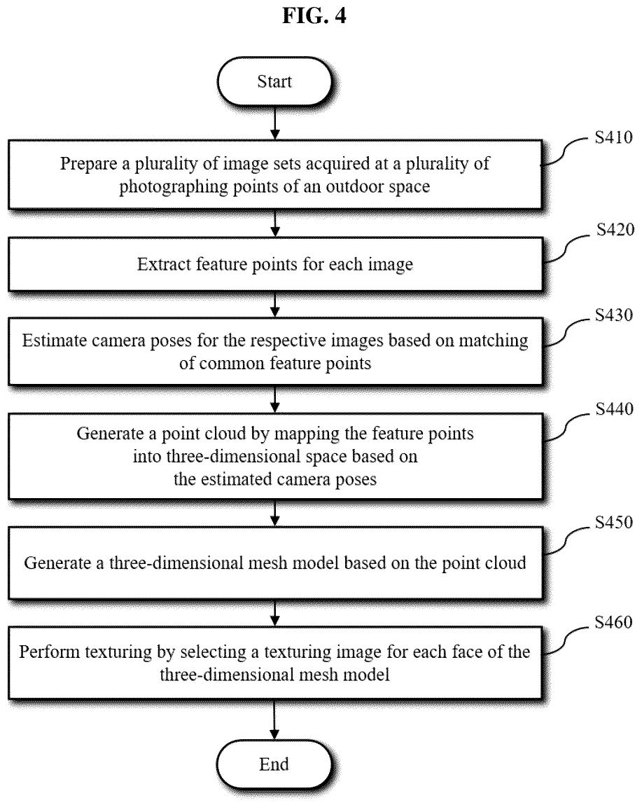

FIG. 3 is a flowchart illustrating a method of providing convergence for heterogeneous three-dimensional virtual models according to an embodiment disclosed in the present application.

The first scan device 101 may generate a plurality of image sets by photographing at a plurality of photographing points of the outdoor space (S301), and transmit the plurality of image sets for the outdoor space to the computing device 300 (S303). Such photographing and transmission may not be performed at the same time, and for example, after collecting a plurality of image sets from the sky through a drone, the plurality of image sets collected through a terminal such as a smartphone interworking with the drone are transmitted to the computing device 300 at once, and the like, and various collection and transmission are possible.

The second scan device 102 may generate a plurality of data sets by photographing at a plurality of photographing points of the indoor space (S302). The second scan device 102 may transmit a plurality of data sets for the real space to the computing device 300 (S304).

The computing device 300 may receive photographing data, that is, a plurality of image sets and a plurality of data sets, from the first scan device 101 and the second scan device 102, and may generate a three-dimensional virtual space model corresponding to an outdoor space/an indoor space, respectively, by using the photographing data.

The computing device 300 may generate a 3D interior digital model for the indoor space by using the plurality of data sets provided from the second scan device 102 (S305).

The computing device 300 may generate a 3D exterior digital model for the outdoor space by using the plurality of image sets provided from the first scan device 101 (S306).

The computing device 300 may perform preprocessing for fusion between the 3D exterior digital model and the 3D interior digital model. Such pre-processing may convert a digital model into a volume model in order to smoothly process matching or scaling between two digital models.

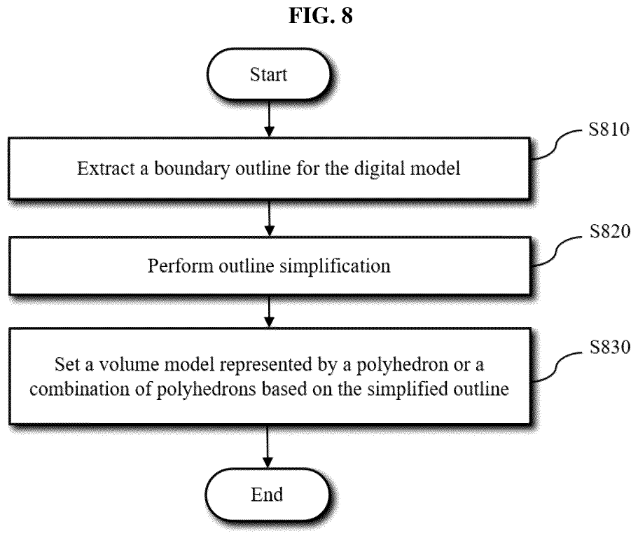

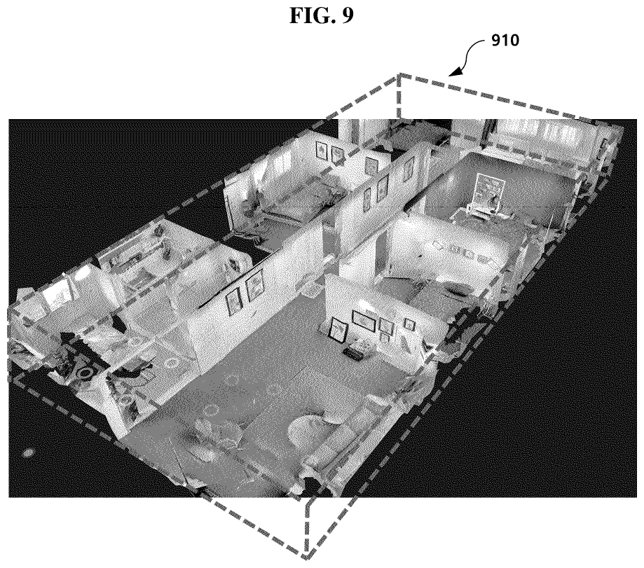

The computing device 300 may generate an outline-based volume model for the interior digital model and the exterior digital model (S307). Hereinafter, the volume model generated from the 3D interior digital model is referred to as an ‘interior volume model’ or a ‘3D interior volume model', and the volume model generated from the 3D exterior digital model is referred to as an 'exterior volume model’ or a ‘3D exterior volume model’. Such a volume model may be easily understood by referring to the contents described below with reference to FIGS. 8 to 9.

The computing device 300 may perform processing for fusion between the 3D exterior digital model and the 3D interior digital model. As the processing for such convergence, matching to match the orientation between the two digital models and scaling to match the ratio between the two digital models may be performed.

For example, the computing device 300 may perform outline-based between the interior and the exterior volume model to determine a registration direction (S308).

As an example, the computing device 300 may perform scaling between two digital models based on the external size comparison between the interior volume model and the exterior volume model (S309).

Thereafter, the computing device 300 may implement a seamless switching interface between different heterogeneous digital models based on such registration and scaling (S310).

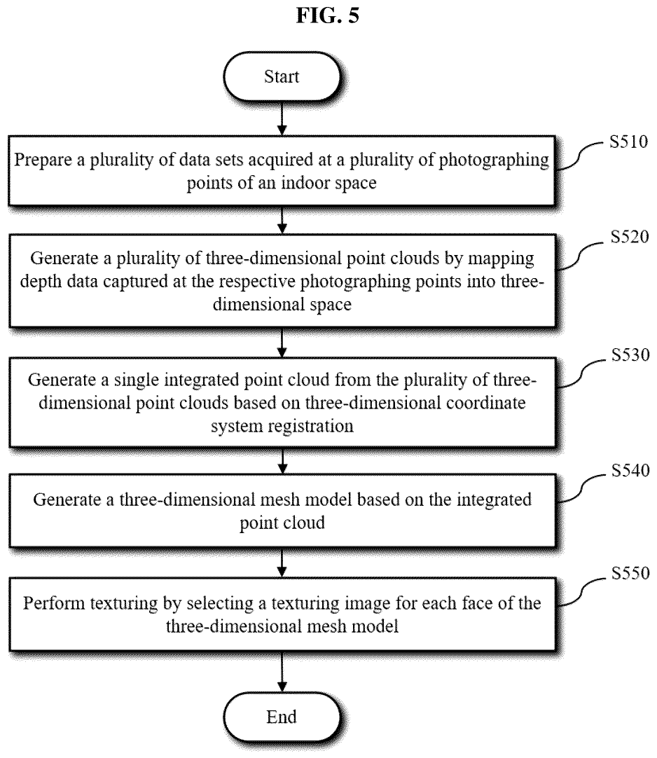

Hereinafter, various specific embodiments for fusion between the computing device 300 and the heterogeneous digital model performed therein will be described with reference to FIGS. 4 to 18.

FIG. 4 is a flowchart illustrating a method of generating a 3D exterior model according to an embodiment disclosed in the present application.

The computing device 300 may prepare a plurality of image sets acquired at a plurality of photographing points of the outdoor space (S410).

The computing device 300 may extract feature points for each image (S420), and estimate a camera pose for each image based on common feature point matching (S430). Here, the feature point may be extracted using various algorithms such as Scale-Invariant Feature Transform (SIFT) or Oriented FAST and Rotated BRIEF (ORB), or using a deep learning model trained to extract the feature point, and a plurality of feature points may be extracted from one image.

The computing device 300 may generate a point cloud by mapping feature points extracted from each image to a 3D space based on the estimated camera pose (S440). The RANSAC algorithm may be used for matching the feature point, but is not limited thereto. For example, a sparse point cloud may be generated by reflecting feature points of various images in one 3D spatial coordinate system, and then a point cloud may be generated by extracting more points based on the sparse point cloud to generate a dense point cloud.

The computing device 300 may generate a 3D mesh model based on the point cloud generated as described above (S450).

Here, the 3D mesh model is a 3D model representing a spatial volume constituting a real space as a set of polygons, and the 3D mesh model may be represented by a plurality of vertices defined in 3D spatial coordinates, an edge connecting the two vertices, and a face partitioned by a plurality of edges. Here, a plurality of vertices may be set based on a point cloud.

For example, the computing device 300 may generate one face based on three adjacent vertices, and in this case, the face may be a flat triangle set to three vertices. As another example, a rectangular face may be set based on four vertices.

The computing device 300 may select a textured image for each face of the 3D mesh model and perform texturing (S460).

The texturing process is performed by selecting a textured image for each face of the mesh model, and then texturing an image area corresponding to an area of the corresponding face in the textured image on the corresponding face. Here, the textured image may be selected in consideration of at least some of various elements such as angle, distance, and resolution with the corresponding face.

That is, the computing device 300 may map a part of the image to the surface of the 3D mesh model to perform texturing to apply a texture similar to each area of the real space, and by completing such texturing, the 3D exterior digital model corresponding to the real outdoor space may be configured. FIG. 6 shows an example of such a 3D exterior digital model, and it can be seen that a 3D digital model is constructed for a fairly wide outdoor area.

FIG. 5 is a flowchart illustrating a method of generating a three-dimensional interior model according to an embodiment disclosed in the present application.

The computing device 300 may prepare a plurality of data sets acquired at a plurality of photographing points of the indoor space (S510).

For example, the computing device 300 may generate a 3D interior model, which is a 3D virtual model corresponding to a real space, by using a plurality of data sets, that is, images and depth data generated at various points in the room, respectively.

In addition, the image used in the exterior model used here is an expression that encompasses all images expressed in color, and is not limited to images of a specific expression method. Accordingly, the color image may be applied to various types of images such as an RFG image represented by red green blue (RGB) and an CMYK image represented by cyan magenta yellow key (CMYK). The depth data is an expression encompassing data providing depth information with respect to the scanned space, and for example, each pixel in the depth data may be distance information from a photographing point to each point in the scanned space to a point in the space corresponding to each pixel.

The computing device 300 may generate a plurality of 3D point clouds by reflecting depth data captured at a plurality of photographing points on the 3D spatial coordinates (S520).

The computing device 300 may generate one integrated point cloud from a plurality of 3D point cloud based on the 3D spatial coordinate system integration (S530).

In the above, an example of a method of configuring one integrated point cloud by configuring each point cloud at individual photographing positions and then projecting the same into a common three-dimensional coordinate system has been described, but is not limited thereto. Therefore, the present invention can be transformed into a method of first projecting each photographing point onto a common 3D coordinate system, generating an individual point cloud at the position of each projected 3D photographing point, and then integrating the individual point cloud.

Such integration requires a process of mapping each photographing point onto 3D spatial coordinates, and for this purpose, coordinate information at each photographing point in indoor space may be used.

The computing device 300 may generate a 3D mesh model based on the integrated point cloud (S540), and may generate a 3D interior digital model by selecting a textured image for each face of the 3D mesh model and performing texturing (S550). Since the 3D mesh model and the texturing process correspond to those described above with reference to FIG. 4, redundant descriptions will be omitted.

Through the above process, a three-dimensional interior digital model corresponding to a real indoor space may be constructed. FIG. 7 illustrates an example of such a 3D interior digital model, and it can be seen that the 3D digital model is configured with high precision and resolution with respect to an indoor space.

FIG. 8 is a flowchart illustrating an outline-based volume model generation method according to an embodiment disclosed in the present application.

Here, the volume model refers to a model that simply expresses the digital model based on the appearance of the digital model, that is, the outline. Referring to the example of FIG. 9, a volume model 910 for a 3D interior digital model is illustrated. Such a volume model may be expressed as a combination of a polyhedron and a polyhedron, and for example, when a building is a target, it may be expressed as a rectangular cuboid or a combination of rectangular cuboids. A step for generating the volume model will be described with reference to FIG. 8.

Referring to FIG. 8, the computing device 300 may extract a plurality of boundary line outlines for the 3D digital model (S810).

As an example, in order to extract the outline, the computing device 300 may detect a plane that is a flat surface such as a ceiling, a floor, or a wall in the 3D digital model, extract a boundary line where the plane and the plane meet, and set the boundary line as the outline. The computing device 300 may use a random sample consensus (RANSAC) algorithm for plane detection, but is not limited thereto. The computing device 300 may perform simplification processing in performing boundary extraction. For example, it is possible to simplify the boundary line in a straight shape by matching the uneven or complex boundary line with the surrounding boundary line. Since the volume model is a model for estimating the overall volume, the detailed shape part is omitted, and through this, the operation of matching and scaling to be described later may be more easily performed.

The computing device 300 may perform outline simplification processing on the plurality of extracted boundary line outlines based on whether they are outermost (S820).

When the boundary line exists inside, for example, the boundary line for the inside of the room is not used when comparing the overall volume, so if the boundary line outline is not the outermost line, it may be deleted and simplified.

The computing device 300 may set a three-dimensional volume model represented by a polyhedron or a combination of polyhedrons based on the simplified outline (S830). FIG. 9 illustrates an example of a volume model in which the above-described overall process is completed, and as illustrated, it may be seen that the volume model is processed into a rectangular cuboid based on the outline of the outermost angle.

The computing device 300 may generate a volume model for each of the interior digital model and the exterior digital model.

That is, the computing device 300 may generate a 3D interior volume model based on the 3D interior digital model, and may generate a 3D exterior volume model based on the 3D exterior digital model.

By calculating the registration or scaling between the two volume models using the interior volume model and the exterior volume model and reflecting the calculated registration or scaling result to the interior digital model and the exterior digital model, which are the source models thereof, it is possible to more efficiently process the registration or scaling between the interior digital model and the exterior digital model.

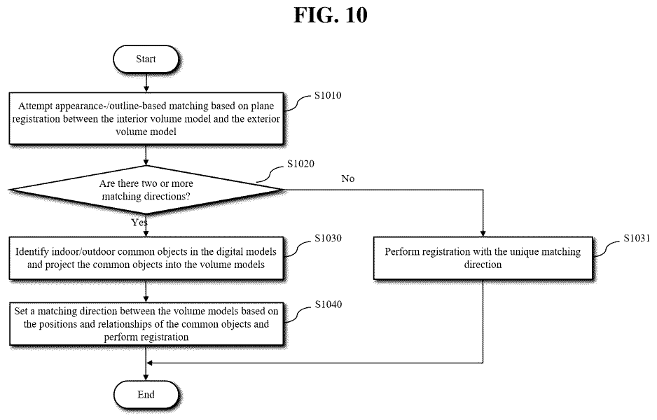

FIG. 10 is a flowchart illustrating a method of registration between heterogeneous digital models according to an embodiment disclosed in the present application.

The computing device 300 may attempt to fit the appearance between the interior volume model and the exterior volume model (S1010).

Here, since the volume model may have a polygonal shape, for example, a rectangular cuboid shape, an external fit between two volume models may be quickly and efficiently attempted using a plane-based alignment.

When a registration direction is specified—that is, when one alignment direction is provided (S1020, NO), the computing device 300 may mutually register the 3D interior volume model and the 3D exterior volume model with the corresponding alignment direction—that is, the only alignment direction (S1031). This is the case when the two volume models are in the form of a cuboid set, etc. For example, when two volume models have a form in which two cuboids such as ‘<’ are joined at a predetermined angle, only one registration is possible in this case.

The computing device 300 may mutually register the two digital models, that is, the three-dimensional interior digital model and the three-dimensional exterior digital model, in response to the mutual registration of the two volume models.

Here, the matching is a positional matching between two volume models, and more broadly, between two digital models, from the result of the matching, a positional association between the two models (for example, a representation through a common three-dimensional coordinate system, etc.) may be set. For example, when two models are implemented in one virtual environment, they may be used to determine positions between the two models. As another example, it may be used to set the position and direction when a transition between two digital models occurs.

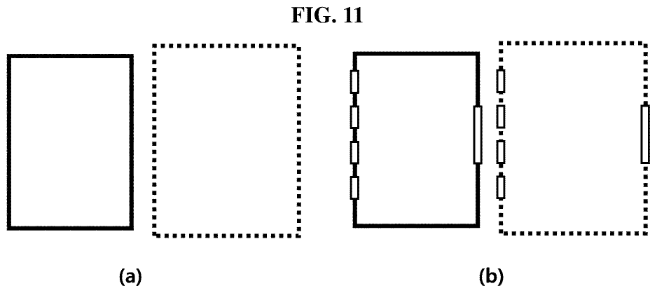

Meanwhile, there may be a case in which two or more registration directions of the two volume models are provided (S1020, Yes). In the example of FIG. 11, the figure (a) shows an example in which the interior digital model—the red solid line—and the exterior digital model—the blue dotted line—are viewed in a plan direction, and in this case, there are two cases in which the interior is matched by being changed by 180 degrees up and down.

Accordingly, in this case, for more accurate matching, the computing device 300 may perform matching based on common object identification (S1030 to S1040).

That is, after identifying the indoor/outdoor common object in the two digital models, the computing device 300 may project the identified indoor/outdoor common object on each of the two volume models (S1030).

Here, the indoor/outdoor common object refers to an object commonly displayed in both the exterior model and the interior model, and for example, the indoor/outdoor common object may be a window.

In the example of FIG. 11, figure (b) shows an example of a volume model on which a window, which is an indoor and outdoor common object, is projected.

The computing device 300 may perform registration by setting the registration direction between the volume models based on the location and relationship of the indoor and outdoor common objects (S1040).

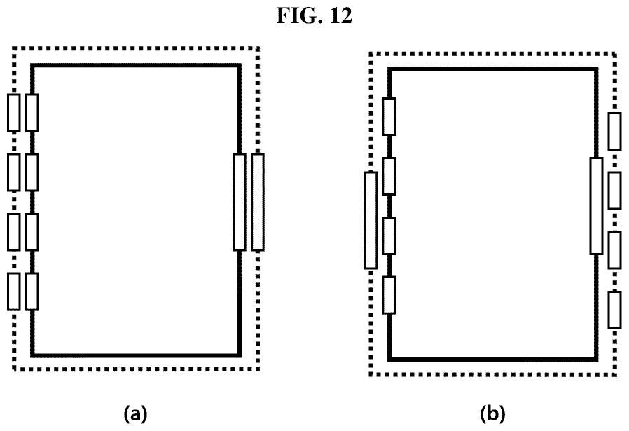

FIG. 12 illustrates two situations in which the figure (b) of FIG. 11 is position-matching, and the figure (a) of FIG. 12 illustrates an example in which two volume models are well matched by projecting the positions of indoor and outdoor common objects. That is, the figure (b) of FIG. 12 exemplifies the case of incorrect matching that may occur without the indoor/outdoor common object, and when the matching is performed by further using the indoor/outdoor common object, precise positional registration may be achieved as shown in the figure (a) of FIG. 12.

In an embodiment, the above-described identification and registration steps S1030 to S1040 of indoor and outdoor common objects may be performed only when the alignment direction is not unique. This requires considerable computing resources and time in the process of identifying indoor and outdoor common objects, so that steps S1030 to S1040 may be executed only when the matching direction is not unique, so that matching may be performed more efficiently.

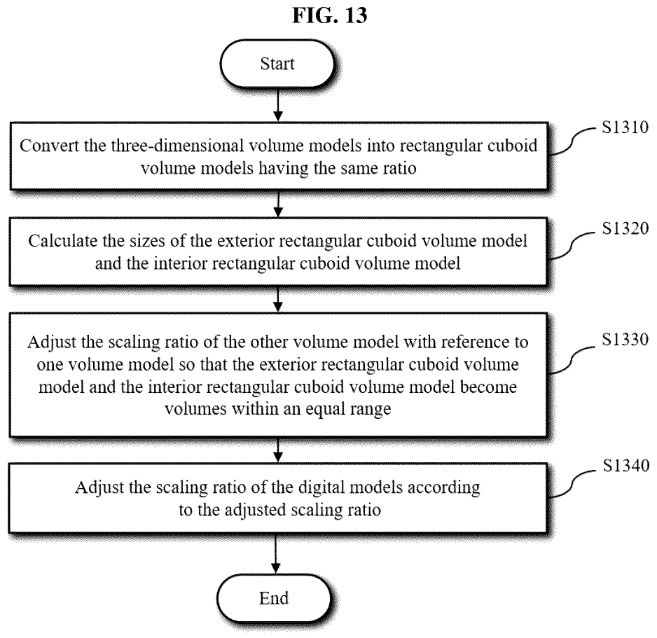

FIG. 13 is a flowchart illustrating a scaling method between heterogeneous digital models according to an embodiment disclosed in the present application.

Here, scaling means to derive a mutually corresponding match for the size between the two digital models.

Referring to FIG. 13, the computing device 300 may convert a 3D volume model into a rectangular cuboid volume model having the same ratio (S1310).

That is, the computing device 300 may convert the 3D interior volume model into an interior rectangular cuboid volume model of the same ratio based on the external size, and may convert the 3D exterior volume model into an exterior rectangular cuboid volume model of the same ratio based on the external size.

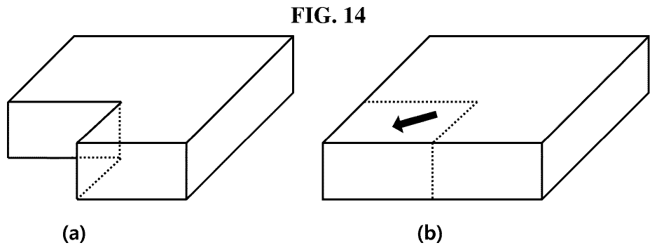

FIG. 14 illustrates this example. Figure (a) of FIG. 14 shows a volume model, and figure (b) of FIG. 14 shows a cuboid volume model. Figure (b) shows an example of filling an empty area and making it a single rectangular cuboid.

As described above, the reason for converting the 3D volume model into a 3D cuboid volume model having the same ratio is to calculate only the scale in this process, that is, to compare the scales without performing a separate registration process.

The computing device 300 may calculate the size of the exterior rectangular cuboid volume model and the interior rectangular cuboid volume model (S1320), and may calculate a scale ratio between the two rectangular cuboid volume models based on this.

The computing device 300 may adjust the scale ratio of the other volume model based on any one volume model so that the exterior cuboid volume model and the interior cuboid volume model become volumes of equal ranges to each other (S1330). The adjusted scale ratio may be stored and managed as scale ratio information between two models.

In an embodiment, the computing device 300 may adjust the scale ratio of the interior cuboid volume model based on the exterior cuboid volume model. In this example, the exterior digital model may configure the digital model based on absolute coordinates such as latitude and longitude information, and the interior digital model may configure the digital model based on relative coordinates such as SLAM. That is, since the exterior digital model implements a digital model based on absolute coordinates, size information of the model may be determined using the absolute coordinates. Accordingly, it is possible to adjust the scale ratio of the interior cuboid volume model based on the exterior cuboid volume model.

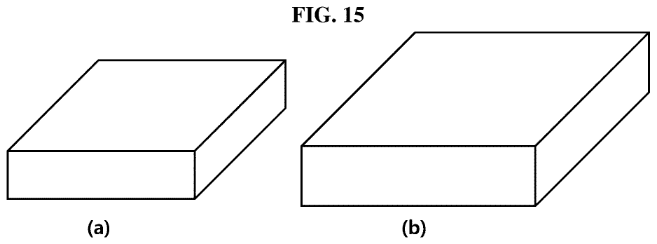

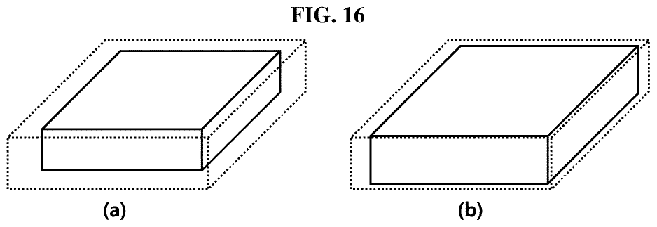

FIG. 15(a) shows an example of an interior cuboid volume model, FIG. 15(b) shows an example of an exterior cuboid volume model, and FIG. 16 shows an example of adjusting a scale between two cuboid volume models of FIG. 15. Figure (a) of FIG. 16 shows an example before scale adjustment, and figure (b) shows an example after scale adjustment.

As shown in FIG. 16(b), the computing device 300 exemplifies an adjustment of scaling up the interior cuboid volume model based on the exterior cuboid volume model so that the interior cuboid volume model and the exterior cuboid volume model become volumes of equal ranges to each other.

Here, the volume in the equal range includes not only when the two volume models are the same, but also including a preset scale free space between the two volume models. Here, the scale free space is set in consideration of the wall thickness of the building, which may be preset or set in proportion to the size of the volume model. Since the scale free space is located outside the interior cuboid volume, a free space may exist between the two cuboid volume models as shown in FIG. 16(b).

The computing device 300 may set the scale ratio of the interior and exterior digital models according to the scale ratio between the two cuboid volume models adjusted as described above (S1340).

Here, the scale ratio is a value for a scale degree of enlarging and reducing any one digital model, and the computing device 300 may individually store and manage the scale ratio between each model.

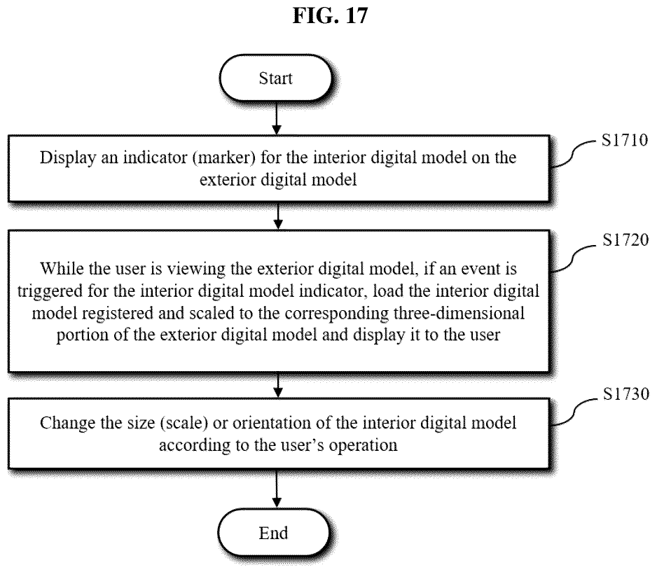

FIG. 17 is a flowchart illustrating a method of providing a seamless switching interface between heterogeneous digital models according to an embodiment disclosed in the present application.

The computing device 300 may obtain the seamless transition interface by adjusting the three-dimensional interior digital model and the three-dimensional exterior digital model based on the registration and the scaling. Such a seamless transition interface is an interface that provides a seamless transition between a 3D interior digital model and a 3D exterior digital model, and reflects positional matching and scale adjustment between two digital models during such a transition, thereby providing a user with a feeling of experiencing the same one digital space even in a transition between two different models.

Referring to FIG. 17, the computing device 300 may display a cover for the interior digital model on the exterior digital model (S1710).

For example, the cover for the interior digital model may be displayed by displaying at least some 3D space corresponding to the interior digital model in the exterior digital model.

For example, the cover for the interior digital model may be displayed by overlaying a 3D volume model for the interior digital model on at least some 3D space of the exterior digital model.

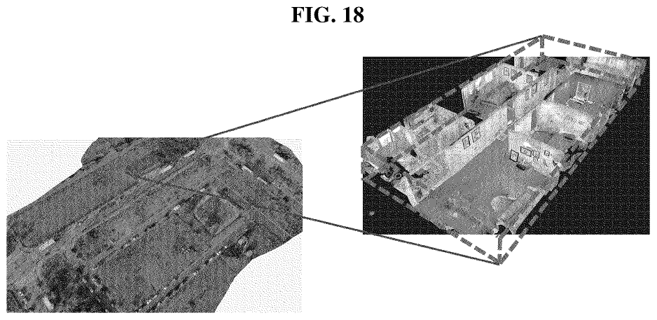

In FIG. 18, it is illustrated that the cover for the interior digital model is displayed in a blue rectangular cuboid in some three-dimensional space corresponding to a building in the exterior digital model.

When the user generates an event such as a click on the interior digital model cover while viewing the exterior digital model, the computing device 300 may load the interior digital model scaled and matched with the corresponding three-dimensional part of the exterior digital model and display it to the user (S1720).

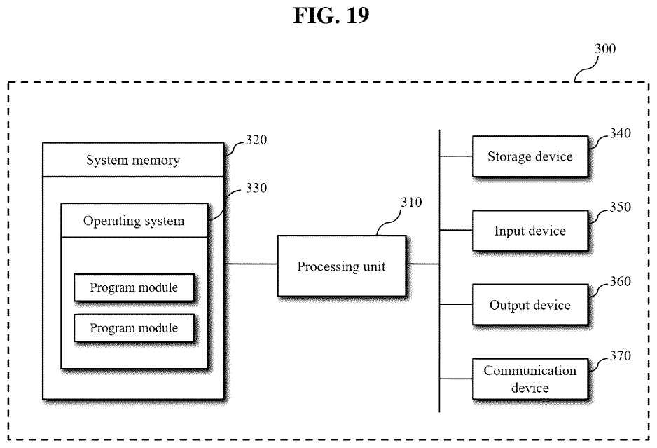

FIG. 19 illustrates such an example. When the user clicks the blue rectangular cuboid, which is the cover of the interior digital model, while viewing the exterior digital model, which is the image on the left, the user's screen is converted into the interior digital model, which is the same as the image on the right, and the conversion at that time may be performed in a form in which the scale is gradually enlarged in a state in which the positions are matched, that is, the transition may be performed seamlessly.

As an example, the seamless switching may be implemented as switching of different digital viewers displaying different objects, that is, the viewer of the interior digital model to be switched may be seamlessly switched in such a way that the viewer is initially displayed in a state in which scale and matching are matched and then gradually enlarged to display the entire viewer.

In this way, the user may experience various interactions with respect to the interior digital model displayed as the entire viewer, and to this end, the computing device 300 may change the size or direction of the interior digital model according to the user's operation (S1730).

FIG. 19 is a diagram illustrating an exemplary environment of a computing device according to an embodiment of the present invention.

FIG. 19 is for providing a general and simplified description of a suitable computing environment in which various embodiments of a computing device may be implemented, and with reference to FIG. 19, a computing device 100 is shown.

The computing device 100 may include at least a processing unit 310 and a system memory 320.

The computing device may include a plurality of processing units that cooperate when executing a program. Depending on the exact configuration and type of computing device, the system memory 301 may be volatile (e.g., RAM), non-volatile (e.g., ROM, flash memory, etc.), or a combination thereof. The system memory 320 includes a suitable operating system 330 for controlling the operation of the platform, which may be, for example, an WINDOWS operating system from Microsoft. The system memory 320 may include one or more software applications, such as program modules, applications, and the like.

The computing device may include additional data storage devices 340 such as magnetic disks, optical disks, or tapes. Such additional storage may be removable storage and/or fixed storage. Computer-readable storage media may include volatile and non-volatile, removable and stationary media embodied in any method or technique for storage information, such as computer-readable instructions, data structures, program modules, or other data. Both the system memory 320 and the data storage device 340 are examples of computer-readable storage media. The computer-readable storage media may include, but are not limited to, RAM, ROM, EEPROM, flash memory or other memory technique, CD-ROM, DVD or other optical storage, magnetic tape, magnetic disk storage or other magnetic storage device, or any other medium capable of storing desired information and being accessed by the computing device 100.

The input device 350 of the computing device may include, for example, a keyboard, a mouse, a pen, a voice input device, a touch input device, and a comparable input device. The output device 360 may include, for example, a display, a speaker, a printer, and other types of output devices. These devices are well known in the art, and thus a detailed description thereof will be omitted.

The computing device may include a communication device 370 that allows the device to communicate with other devices, such as via a network in a distributed computing environment, e.g., a wired/wireless network, a satellite link, a cellular link, a local area network, and a comparable mechanism. The communication device 370 is one example of a communication medium, which may include computer-readable instructions, data structures, program modules, or other data therein. For example, the communication medium includes a wired medium such as a wired network or a direct connection, and a wireless medium such as acoustic, RF, infrared, and other wireless media, but is not limited thereto.

As described above, although the embodiments have been described with reference to the limited embodiments and drawings, those skilled in the art may make various modifications and variations from the above description. For example, appropriate results may be achieved even if the described techniques are performed in a different order than the described method, and/or if components of the described system, structure, apparatus, circuit, etc. are combined in a different form than the described method, or are replaced or substituted by other components or equivalents.

Therefore, other implementations, other embodiments, and equivalents of the claims are within the scope of the claims to be described later.

As described above, although the detailed description of the present document has been described with respect to specific embodiments, it will be obvious to a person skilled in the art that various modifications are possible without departing from the scope of the present document.

### REFERENCE

The present invention has been applied overseas with the support of the following research projects supported by the Korean government.
Project Identification Number: 2710018107
Project Number: 00460360
Ministry name: Ministry of Science and ICT
Project Management (Specialized) Agency: Institute for Information and Communications Technology Planning and Evaluation
Research Project Name: SW Computing Industry Source Technology Development
Research Project Title: Development and standardization of space convergenced digital twin technology that combines a wide-area exterior digital model and a high-density interior digital model
The name of the institution performing the project: 3i Co., Ltd.
Research period: 2024.07.01˜2024.12.31

What is claimed is:

1. A three-dimensional registration method performed in a computing device providing a three-dimensional virtual model for a real space, the three-dimensional registration method comprising:
generating a three-dimensional interior digital model for the indoor space using a plurality of data sets collected in the indoor space;
generating a three-dimensional exterior digital model for the outdoor space using a plurality of image sets collected in an outdoor space;
generating an outline-based three-dimensional volume model for the three-dimensional interior digital model and the three-dimensional exterior digital model; and
performing registration between the three-dimensional interior digital model and the three-dimensional exterior digital model based on external alignment between the three-dimensional interior volume model and the three-dimensional exterior volume model.

2. The three-dimensional registration method of claim 1, wherein the plurality of data sets respectively acquired at a plurality of capture points within the indoor space, and comprise:
a 360-degree panoramic image;
360-degree panoramic depth data; and
indoor location information for each of the plurality of photographing points.

3. The method of claim 2, wherein the generating of the three-dimensional interior digital model comprises:
generating a plurality of individual three-dimensional point clouds by reflecting depth data captured at a corresponding photographing point on individual three-dimensional spatial coordinates with respect to each of the plurality of data sets;
generating one integrated three-dimensional point cloud integrating the plurality of individual three-dimensional point clouds by reflecting the individual three-dimensional spatial coordinates in one integrated three-dimensional spatial coordinate based on the indoor location information;
generating a three-dimensional mesh model based on the integrated three-dimensional point cloud; and
generating the three-dimensional interior digital model by individually selecting texturing images with respect to each of a plurality of faces included in the three-dimensional mesh model.

4. The three-dimensional registration method of claim 3, wherein the plurality of image sets include a plurality of images acquired at a plurality of photographing points located in the sky of the outdoor space by a drone.

5. The three-dimensional registration method of claim 4, wherein the generating of the three-dimensional exterior digital model comprises:
extracting feature points for each of the plurality of images included in the plurality of image sets;
estimating a camera pose for each of the plurality of images based on common feature point matching;
generating a three-dimensional point cloud by mapping feature points of each image to a three-dimensional space based on the estimated camera pose;
generating a three-dimensional mesh model based on the three-dimensional point cloud; and
generating the three-dimensional exterior digital model by individually selecting texturing images for each of a plurality of faces included in the three-dimensional mesh model and performing texturing thereon.

6. The three-dimensional registration method of claim 5, wherein the generating of the outline-based three-dimensional volume model comprises:
extracting a plurality of boundary line outlines for the three-dimensional digital model;
simplifying the extracted plurality of boundary line outlines based on whether they are outermost; and
generating a three-dimensional volume model by a polyhedron or a combination of polyhedrons based on the simplified outline.

7. The three-dimensional registration method of claim 6, wherein the generating of the outline-based three-dimensional volume model comprises:
generating a three-dimensional interior volume model based on the three-dimensional interior digital model; and
generating a three-dimensional exterior volume model based on the three-dimensional exterior digital model.

8. The three-dimensional registration method of claim 7, wherein the performing of the registration between the three-dimensional interior digital model and the three-dimensional exterior digital model comprises:
performing outline-based matching between the three-dimensional interior volume model and the three-dimensional exterior volume model based on plane registration;
when a registration direction is specified, mutually registering the three-dimensional interior volume model and the three-dimensional exterior volume model in a corresponding registration direction; and
registering the three-dimensional interior digital model and the three-dimensional exterior digital model in response to the mutual registration.

9. A computing device comprising:
at least one processor; and a memory configured to store instructions,
wherein the instructions, when executed individually or collectively by the at least one processor, cause the processor to:
generate a three-dimensional interior digital model for an indoor space using a plurality of data sets collected in the indoor space;
generate a three-dimensional exterior digital model for the outdoor space using a plurality of image sets collected in the outdoor space;
generate an outline-based three-dimensional volume model for the three-dimensional interior digital model and the three-dimensional exterior digital model; and
register the three-dimensional interior digital model and the three-dimensional exterior digital model based on appearance-based matching between the three-dimensional interior volume model and the three-dimensional exterior volume model.

10. The computing device of claim 9, wherein the instructions, when executed individually or collectively by the at least one processor, cause the processor to:
extract a plurality of boundary line outlines from the three-dimensional digital model,
simplify the extracted plurality of boundary line outlines based on whether they are outermost, and
generate a three-dimensional volume model by combining a polyhedron and a polyhedron based on the simplified outline, in order to generate the outline-based three-dimensional volume model.

11. The computing device of claim 10, wherein the instructions, when executed individually or collectively by the at least one processor, cause the processor to:
generate a three-dimensional interior volume model based on the three-dimensional interior digital model to generate the outline-based three-dimensional volume model, and
generate a three-dimensional exterior volume model based on the three-dimensional exterior digital model.

12. The computing device of claim 11, wherein the instructions, when executed individually or collectively by the at least one processor, cause the processor to perform three-dimensional matching for different three-dimensional virtual models,
wherein the processor performs external fitting between the three-dimensional interior volume model and the three-dimensional exterior volume model based on plane registration, when a matching direction is specified, performs mutual registration between the three-dimensional interior volume model and the three-dimensional exterior volume model in a corresponding matching direction, and matches the three-dimensional interior digital model and the three-dimensional exterior digital model in response to the mutual registration, in order to register the three-dimensional interior digital model and the three-dimensional exterior digital model.
